(19) United States
(12) Patent Application Publication
(10) Pub. No.: US 2024/0360914 A1
(43) Pub. Date: Oct. 31, 2024

(54) FLUID CONTROL VALVE, FLUID CONTROL DEVICE, AND MATERIAL SUPPLY SYSTEM

(71) Applicant: HORIBA STEC, Co., Ltd., Kyoto-shi (JP)

(72) Inventors: Kazuo HANADA, Kyoto-shi (JP); Akihiro TAGUCHI, Kyoto-shi (JP); Kenta TAYAMA, Kyoto-shi (JP)

(21) Appl. No.: 18/642,642

(22) Filed: Apr. 22, 2024

(30) Foreign Application Priority Data
Apr. 28, 2023 (JP) 2023-074429

(51) Int. Cl. F16K 27/00; F16K 31/00

(52) U.S. Cl. CPC F16K 27/00; F16K 31/004

(57) ABSTRACT

A fluid control valve includes a casing, and a piezo actuator that is housed in the casing and held at one end side of the casing to extend toward another end side of the casing, where the casing has a vent hole.

### CROSS-REFERENCE TO RELATED APPLICATIONS

This application claims priority to Japanese Patent Application No. 2023-074429 filed on Apr. 28, 2023, which is incorporated herein by reference in its entirety.

### BACKGROUND OF THE INVENTION

### 1. Technical Field

The present invention relates to a fluid control valve, a fluid control device, and a material supply system.

### 2. Description of the Related Art

As disclosed in Patent Document 1, there is a conventional fluid control valve in which a valve body is brought into contact with and separated from a valve seat by expansion and contraction of a piezo actuator including laminated piezoelectric elements by applying a drive voltage to the piezo actuator.

There are cases where a material gas having a high vaporization temperature is used due to, for example, diversification of manufacturing processes of semiconductors in recent years. To supply such a material gas without causing gas liquification, heating of a mass flow controller including the fluid control valve described above while using is necessary in some cases.

However, the lifetime of a piezoelectric element under a high temperature condition is significantly short, and thus the mass flow controller needs to be replaced after a short period of time. To replace a mass flow controller, a material gas supply line needs to be opened, and to do so, a semiconductor manufacturing apparatus needs to be stopped. This causes a reduction in productivity of the semiconductor manufacturing process.

### PRIOR ART DOCUMENT

### Patent Document

JP 2022-191116 A

### SUMMARY OF THE INVENTION

The present invention has been made to solve the problems described above. A main object of the present invention is to extend the life of a piezo actuator to reduce replacement frequency also in a case where a high-temperature fluid is controlled.

A fluid control valve according to an embodiment of the present invention includes a casing, and a piezo actuator that is housed in the casing and held at one end side of the casing to extend toward the other end side of the casing, the casing having a vent hole.

This fluid control valve having the vent hole in the casing can release the heat in the casing to the outside and can thereby reduce the temperature of the piezo actuator. Thus, also in a case where a high-temperature fluid is controlled, the lifetime of the piezo actuator can be extended, and the replacement frequency of a mass flow controller can be reduced, which contributes to improvement of the productivity in the semiconductor manufacturing process.

The vent hole is desirably formed at a plurality of places on the casing.

In this configuration, a larger amount of hot air can be released out of the casing to further reliably reduce the temperature of the piezo actuator.

Specific embodiments include an aspect in which the vent holes are formed at a plurality of places along the circumferential direction of the casing and an aspect in which the vent holes are formed at a plurality of places along the axial direction of the casing.

Some of a plurality of vent holes desirably have a size or shape different from that of the other vent holes.

In this configuration, a plurality of vent holes can appropriately be made for various purposes, for example, forming small vent holes at places where the casing needs a high mechanical strength and large vent holes at other places.

It is desirable that the vent hole is formed on each of one end side and the other end side of the casing, and the gas flowing in through the vent hole on the other end side of the casing passes inside the casing and flows out from the vent hole on the one end side of the casing.

This configuration allows the gas to pass inside the casing by natural convection with no help of external air blow or the like.

A fluid control device according to an embodiment of the present invention includes the fluid control valve described above, a fluid detection device that detects fluid controlled by the fluid control valve, and a main case that houses the fluid control valve and the fluid detection device.

According to the fluid control device configured in this manner, the same effect as that of the fluid control valve described above can be obtained.

It is desirable that a part of the fluid control valve protrudes from the main case.

In this configuration, hot air in the casing can be released out of the main case to inhibit stagnation of hot air in the main case, and this can further reliably lower the temperature of the piezo actuator.

A second vent hole is desirably formed in the main case.

In this configuration, hot air in the main case can be released to the outside, and thereby overheating in the main case can be further suppressed.

The second vent hole is desirably formed in each of surfaces of the main case facing opposite directions.

In this configuration, ventilation in the main case can be improved.

It is desirable that the surfaces facing opposite directions are a vertically downward facing surface and a vertically upward facing surface, and the gas flowing in through the second vent hole in the vertically downward facing surface passes inside the main case to flow out from the second vent hole in the vertically upward facing surface.

This configuration allows the gas to flow inside the main case by natural convection with no help of external air blow or the like.

When the gas flowing into the main case is introduced to the fluid detection device and cools the fluid detection device, an error may occur in flow rate measurement.

Thus, it is desirable that a flow path of the gas flowing into the main case from the second vent hole is formed to bypass the fluid detection device.

This configuration can inhibit thermal influence on the fluid detection device.

It is desirable to further include a shielding member housed in the main case to shield the fluid detection device from the gas flowing into the main case from the second vent hole.

This configuration can more reliably inhibit introduction of gas to the fluid detection device.

A material supply system according to an embodiment of the present invention includes the fluid control device described above, and supplies a liquid material or a material gas obtained by vaporizing a liquid material to a predetermined supply destination.

According to the material supply system configured in this manner, the same effect as that of the fluid control valve and the fluid control device described above can be obtained.

It is desirable to include an outer case that houses the fluid control device and includes a purge gas introduction port so that the purge gas introduced from the purge gas introduction port passes inside the main case and flows through the second vent hole in the main case.

In this configuration, convection of hot air can be generated in the main case using an existing purge gas.

The fluid control valve according to an embodiment of the present invention includes a casing, and a piezo actuator including a piezoelectric element covered with an expandable covering member and housed in the casing, where a vent hole is formed in the casing.

This fluid control valve having the vent hole in the casing can release the heat in the casing to the outside and can thereby reduce the temperature of the piezo actuator. Thus, also in a case where a high-temperature fluid is controlled, the lifetime of the piezo actuator can be extended, and the replacement frequency of the mass flow controller can be reduced, which contributes to improvement of the productivity in the semiconductor manufacturing process.

Meanwhile, in a conventional fluid control device, the fluid control valve is housed in the main case, and when the fluid control valve needs to be replaced due to expiration of the life of a piezo actuator, for example, the whole fluid control device, including components that don't need replacement, needs to be replaced with a new one.

In this regard, an object of the present invention is to enable replacement of a fluid control valve with a new one without replacing the whole fluid control device.

That is, a fluid control device according to an embodiment of the present invention includes a block body including an internal flow path, a fluid control valve that controls a fluid flowing in the internal flow path, and a main case that is attached to the block body and houses the fluid control valve, the fluid control valve being accessible without detaching the main case from the block body.

According to the fluid control device configured in this manner, the fluid control valve can be accessed without removing the main case, so that the fluid control valve can be replaced with a new one without replacing the whole fluid control device.

It is desirable that the fluid control valve includes a piezo actuator housed in a casing, a part of the casing on a side opposite to the block body is a detachable cap, and at least the cap protrudes from the main case.

This allows easy access to the cap without removing the main case, so that the fluid control valve can be easily replaced with a new one without removing the main case.

It is desirable that an opening is formed in the main case at a place facing the fluid control valve, and the fluid control valve is accessible through the opening.

This allows the whole fluid control valve to be housed in the main case, and can exhibit the effect described above.

It is desirable to include an opening/closing mechanism that opens and closes the opening.

This allows access to the fluid control valve without removing the main case, and secures internal air tightness of the main case.

It is desirable that parts surrounding the fluid control valve in the main case are detachable.

In this configuration, the fluid control valve can be accessed easily by removing the parts surrounding the fluid control valve.

According to the present invention described above, also in a case where a high-temperature fluid is controlled, the lifetime of a piezo actuator can be extended, and the replacement frequency of a mass flow controller can be reduced, which contributes to improvement of the productivity in a semiconductor manufacturing process.

### BRIEF DESCRIPTION OF THE DRAWINGS

FIG. 1 is a schematic diagram illustrating an overall configuration of a material supply system according to a first embodiment of the present invention;

FIG. 2 is a schematic view illustrating a configuration of a fluid control device according to the embodiment;

FIG. 3 is a schematic view illustrating a configuration of a fluid control device according to an exemplary modification of the first embodiment;

FIG. 4 is a schematic view illustrating a configuration of a fluid control device according to an exemplary modification of the first embodiment;

FIG. 5 is a schematic view illustrating a configuration of a fluid control device according to an exemplary modification of the first embodiment;

FIG. 6 is a schematic view illustrating a configuration of a fluid control device according to an exemplary modification of the first embodiment;

FIG. 7 is a schematic view illustrating a configuration of a fluid control device according to an exemplary modification of the first embodiment;

FIG. 8 is a schematic view illustrating a configuration of a fluid control device according to an exemplary modification of the first embodiment;

FIG. 9 is a schematic view illustrating a configuration of a fluid control device according to an exemplary modification of the first embodiment;

FIG. 10 is a schematic view illustrating a configuration of a fluid control device according to a second embodiment;

FIG. 11 is a schematic view illustrating a configuration of a fluid control device according to an exemplary modification of the second embodiment;

FIG. 12 is a schematic view illustrating a configuration of a fluid control device according to an exemplary modification of the second embodiment; and

FIG. 13 is a schematic view illustrating a configuration of a fluid control device according to an exemplary modification of the second embodiment.

### DETAILED DESCRIPTION

### First Embodiment

A fluid control valve, a fluid control device including the fluid control valve, and a material supply system including the fluid control device according to a first embodiment of the present invention will be described with reference to the drawings.

### <Device Configuration>

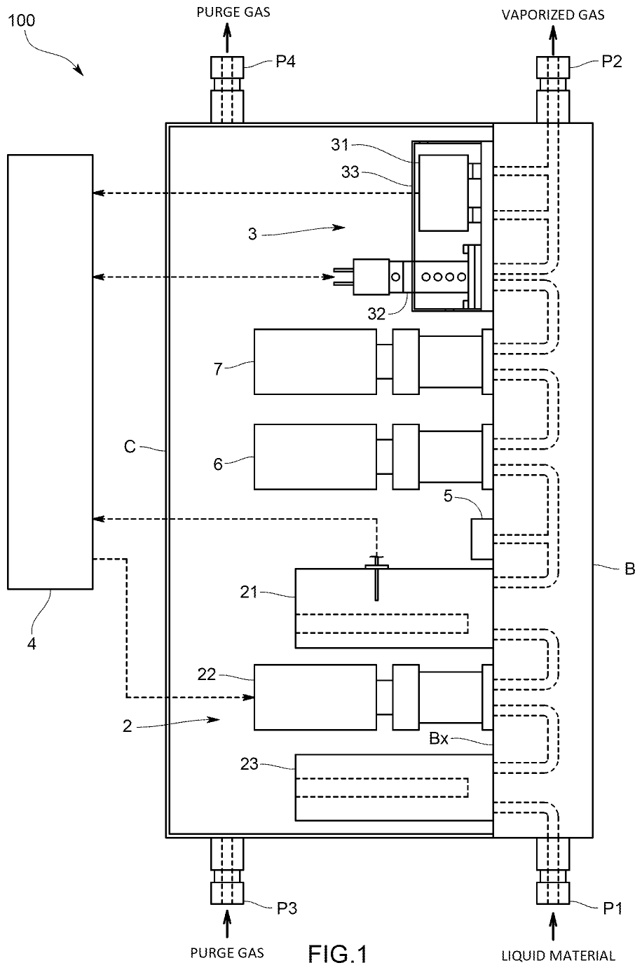

As illustrated in FIG. 1, a material supply system 100 of the present embodiment is for supplying a liquid material or a material gas obtained by vaporizing a liquid material to a predetermined supply destination. The material supply system 100 here is, for example, a vaporizing system for supplying a material gas at a predetermined flow rate to a chamber assembled in, for example, a semiconductor manufacturing line to perform a semiconductor manufacturing process.

Specifically, the vaporizing system 100 includes a vaporizing unit 2 that vaporizes a liquid raw material, a mass flow controller 3 that is a fluid control device that controls the flow rate of the gas vaporized by the vaporizing unit 2, and a control device 4 that controls operations of the vaporizing unit 2 and the mass flow controller 3. The vaporizing unit 2 and the mass flow controller 3 are housed in an outer case C having a substantially long-columnar shape (specifically, a substantially rectangular parallelepiped shape).

An introduction port P1 for introducing a liquid material is provided on one end side in the longitudinal direction of the outer case C, and a lead-out port P2 for leading out the material gas is provided on the other end side in the longitudinal direction. In the outer case C of the present embodiment, a purge gas introduction port P3 is provided on the one end side in the longitudinal direction, and a purge gas lead-out port P4 is provided on the other end side in the longitudinal direction, so that a purge gas such as nitrogen gas passes inside the outer case C.

The vaporizing unit 2 includes a vaporizer 21 that vaporizes a liquid material by the baking method, a supply amount control device 22 that controls a supply amount of the liquid material to the vaporizer 21, and a preheater 23 that preheats the liquid material supplied to the vaporizer 21 to a predetermined temperature.

The vaporizer 21, the supply amount control device 22, and the preheater 23 are attached to one surface of a main block B which is a manifold block including an internal flow path. The main block B is made of a metal such as stainless steel, for example, and has a substantially long-columnar shape (specifically, a substantially rectangular parallelepiped shape), and a device mounting surface Bx is a surface having a long rectangular shape. Note that the main block B is installed in a semiconductor manufacturing line or the like such that the longitudinal direction of the main block B is oriented along the up-down direction (vertical direction).

In the vaporizing unit 2 configured as described above, the liquid material introduced from the introduction port P1 flows in a flow path in the preheater 23 to be preheated to a predetermined temperature. The liquid material preheated by the preheater 23 is intermittently introduced, controlled by an electromagnetic on-off valve, that is, the supply amount control device 22, into the vaporizer 21. The material gas is continuously generated by vaporization of the liquid material in the vaporizer 21 and is led to the mass flow controller 3. The liquid material of the embodiment has a vaporization temperature of 100° C. or higher, for example.

Next, the mass flow controller 3 will be described.

As illustrated in FIG. 1, the mass flow controller 3 is provided downstream of the vaporizing unit 2 described above and controls the flow rate or pressure of the material gas obtained by vaporizing the liquid material by the vaporizing unit 2. Specifically, the mass flow controller 3 includes a fluid detection device 31 that detects material gas flowing in the flow path, a fluid control valve 32 that controls the flow rate or pressure of the material gas flowing in the flow path, and a main case 33 that houses the fluid detection device 31 and the fluid control valve 32. In the present embodiment, an upstream pressure sensor 5, an on-off valve 6, and a purge on-off valve 7 are provided on the upstream of the mass flow controller 3, but the specific embodiment is not limited to this configuration, and may be appropriately changed.

The fluid detection device 31 is of a thermal type including a heater (not illustrated) provided in a narrow tube connected in parallel to the internal flow path of the main block B and a pair of temperature sensors (not illustrated) provided in the upstream and the downstream of the heater. However, the fluid detection device 31 is not limited to that of a thermal type, but may be of a differential pressure type.

The fluid control valve 32 is of a type called a piezo valve, and controls the flow rate of the material gas generated by the vaporizer 21. The fluid control valve 32 and the structure surrounding the fluid control valve 32 are features of the embodiment, which will be described later.

As illustrated in FIG. 1, the fluid detection device 31 and the fluid control valve 32 are mounted on the device mounting surface Bx. All or some of the components described above are housed and packaged in the main case 33 attached to the block body B.

In the present embodiment, to inhibit liquification of the material gas, a heater for heating the mass flow controller 3 and/or the main block B is provided, and the mass flow controller 3, at least the main block B side thereof, is temperature-controlled to a temperature higher than the vaporization temperature of the material gas.

The control device 4 supplies the liquid material to the vaporizer 21 during a vaporizing operation by controlling the electromagnetic on-off valve, that is, the supply amount control device 22 described above.

The control device 4 obtains an output signal from the fluid detection device 31 to calculate the flow rate of the material gas, and applies a drive voltage to the fluid control valve 32 to feedback-control the valve opening so that the calculated flow rate becomes a set flow rate that is set in advance.

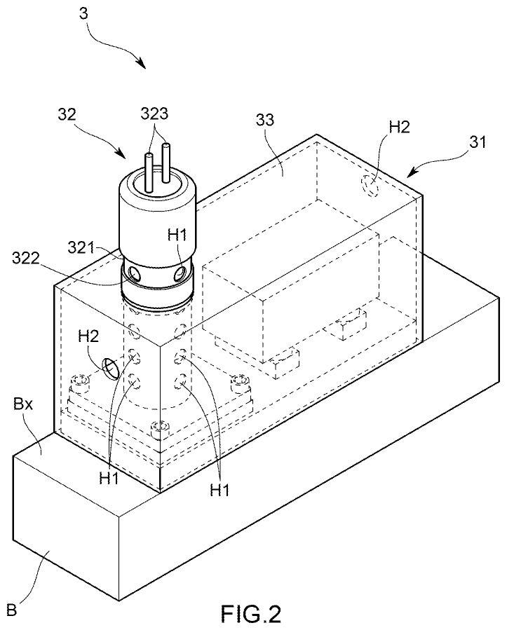

The fluid control valve 32 of the present embodiment is called a piezo valve as described above. Specifically, the fluid control valve 32 includes, as illustrated in FIG. 2, a casing 321 and a piezo actuator 322 housed in the casing 321, and is configured such that a valve body (not illustrated) comes into contact with and separates from a valve seat (not illustrated) by expansion and contraction of the piezo actuator 322.

To explain more specifically, the piezo actuator 322 includes a piezoelectric element covered by an expandable bellows-shaped, for example, covering member (not illustrated), and is held at one end side of the casing 321 to extend toward the other end side of the casing 321. The one end side of the casing 321 is a side provided with a terminal 323 to which the drive voltage is applied, and the other end side of the casing 321 is a side on which the main block B having the internal flow path is provided (in other words, the side on which the valve body and the valve seat (not illustrated) are provided). It may be configured that the one end side of the casing 321 is a side on which the main block B is provided, and the other end side of the casing 321 is a side on which the terminal 322 is provided.

The casing 321 encloses the piezo actuator 322 and stably holds one end side of the piezo actuator 322 to allow the piezo actuator 322 to extend toward the other end to exhibit the function of the piezo actuator 322. Specifically, the casing 321 has a sleeve shape such as a cylindrical sleeve.

As illustrated in FIG. 2, a vent hole H1 is formed in the casing 321. The vent hole H1 is for releasing the hot air in the casing 321 to the outside, in other words, for taking the outside gas into the casing 321 and sending the gas inside the casing 321 to the outside. That is, the ventilation here means to let gas pass through the outside and the inside of the casing 321.

The vent hole H1 penetrates the outer circumferential surface of the casing 321 at a place facing the outer circumferential surface of the piezo actuator 322 housed in the casing 321.

In the present embodiment, as illustrated in FIG. 2, the vent holes H1 are formed at a plurality of places on the outer circumferential surface of the casing 321. Specifically, the vent holes H1 are formed at a plurality of places along the circumferential direction on the outer circumferential surface of the casing 321 and at a plurality of places along the axial direction on the outer peripheral surface of the casing 321.

Although these vent holes H1 have the same size and the same shape in this embodiment, some of a plurality of vent holes H1 may have a size or shape different from that of the other vent holes H1.

In the casing 321 of the present embodiment, the vent holes H1 are formed at least on the one end side and the other end side of the casing 321, considering that the temperature on the other end side becomes higher than the temperature on the one end side due to heating by the heater described above.

Since high-temperature gas flows toward a low temperature side, natural convection is generated in the casing 321 between the vent hole H1 on the one end side of the casing 321 and the vent hole H1 on the other end side, which causes the gas flowing in through the vent hole H1 on the other end side of the casing 321 to pass inside the casing 321 to flow out from the vent hole H1 on the one end side of the casing 321.

As illustrated in FIG. 1, the casing 321 of the present embodiment is oriented along a direction intersecting the vertical direction (in the embodiment, oriented along a horizontal direction) when used. In this orientation, at least the vent hole H1 facing vertically downward and the vent hole H1 facing vertically upward may be formed. Since high-temperature gas ascends, natural convection (upward airflow) is generated between the vertically downward facing vent hole H1 and the vertically upward facing vent hole H1, which causes the gas flowing into the casing 321 through the vertically downward vent hole H1 to flow inside the casing 321 and flow out from the vertically upward facing vent hole H1.

In an aspect that is more desirable in terms of effectiveness of generating the natural convection described above, the vent hole H1 facing vertically upward is formed on the one end side of the casing 321 and the vent hole H1 facing vertically downward is formed on the other end side of the casing 321.

As illustrated in FIG. 2, at least a part of the fluid control valve 32 of the present embodiment protrudes from the main case 33, specifically, at least a part of the casing 321 constituting the fluid control valve 32 protrudes from the main case 33.

In this configuration, one or a plurality of vent holes H1 are formed in a portion of the casing 321 protruding from the main case 33, and hot air in the casing 321 flows out of the main case 33 through the vent holes H1.

As illustrated in FIGS. 1 and 2, the main case 33 has second vent holes H2. Note that the second vent holes H2 are for releasing the hot air inside the main case 33 to the outside of the main case 33, in other words, for taking the outside gas into the main case 33 and sending the gas inside the main case 33 to the outside. That is, the ventilation here means to let gas pass through the outside and the inside of the main case 33.

The second vent holes H2 penetrate the outer circumferential surface of the main case 33. The second vent holes H2 here are formed at a plurality of places on the outer circumferential surface of the main case 33. Specifically, at least one second vent hole H2 is formed at a place facing the outer circumferential surface of the casing 321 constituting the fluid control valve 32.

In the present embodiment, the second vent hole H2 is formed on each of surfaces of the main case 33 facing opposite directions. With the fluid control valve 32 oriented along a direction intersecting the vertical direction when used, the surfaces facing opposite directions are a vertically downward facing surface and a vertically upward facing surface as illustrated in FIG. 2.

Since high-temperature gas ascends, natural convection (upward airflow) is generated in the main case 33 in this configuration between the second vent hole H2 in the vertically downward surface and the second vent hole H2 in the vertically upward facing surface, which causes the gas flowing in through the second vent hole H2 in the vertically downward surface to pass inside the main case 33 and flow out from the second vent hole H2 in the vertically upward facing surface.

In the present embodiment, in addition to the natural convection described above, the purge gas introduced from the purge gas introduction port provided in the outer case C flows into the main case 33 through the second vent hole H2 in the vertically downward facing surface, and the purge gas flows out of the main case 33 through the second vent hole H2 in the vertically upward facing surface.

That is, the hot air in the main case 33 flows out of the main case 33 by natural convection (upward air flow) as well as by being carried with the purge gas.

### Effects of Present Embodiment

The fluid control valve 32 configured in this manner has the vent hole H1 in the casing 321, so that the heat in the casing 321 can be released to the outside of the casing 321 and thereby the temperature of the piezo actuator 322 can be reduced. Thus, also in a case where a high-temperature fluid is controlled, the lifetime of the piezo actuator 322 can be extended and the replacement frequency of the mass flow controller 3 can be reduced, which contributes to improvement of the productivity in the semiconductor manufacturing process.

Since a plurality of vent holes H1 are formed in the casing 321, a larger amount of hot air in the casing 321 can be released to further reliably reduce the temperature of the piezo actuator 322.

Furthermore, since the vent hole H1 is formed in each of the one end side and the other end side of the casing 321, the gas flowing in through the vent hole H1 on the other end side of the casing 321 passes inside the casing 321 and flows out through the vent hole H1 on the one end side of the casing 321 by natural convection with no help of external air blow or the like.

In addition, since a portion of the fluid control valve 32 protrudes from the main case 33, the hot air in the casing 321 can be released to the outside of the main case 33 to inhibit stagnation of hot air in the main case 33, and this can further reliably lower the temperature of the piezo actuator 322.

In addition, since the second vent hole H2 is formed in the main case 33, the hot air in the main case 33 can be released to the outside, thereby suppressing stagnation of hot air in the main case 33.

Furthermore, since the second vent hole H2 is formed in each of the surfaces of the main case 33 facing opposite directions, ventilation in the main case 33 can be improved.

Furthermore, since the surfaces facing opposite directions are the vertically downward facing surface and the vertically upward facing surface, the gas flowing in through the second vent hole H2 in the vertically downward facing surface can pass inside the main case 33 and flow out through the second vent hole H2 in the vertically upward facing surface by natural convection with no help of external air blow or the like.

Moreover, since the purge gas flows through the main case 33, the hot air in the main case 33 can be carried out to the outside of the main case 33 not only by the natural convection described above but also with the purge gas.

### Exemplary Modification of First Embodiment

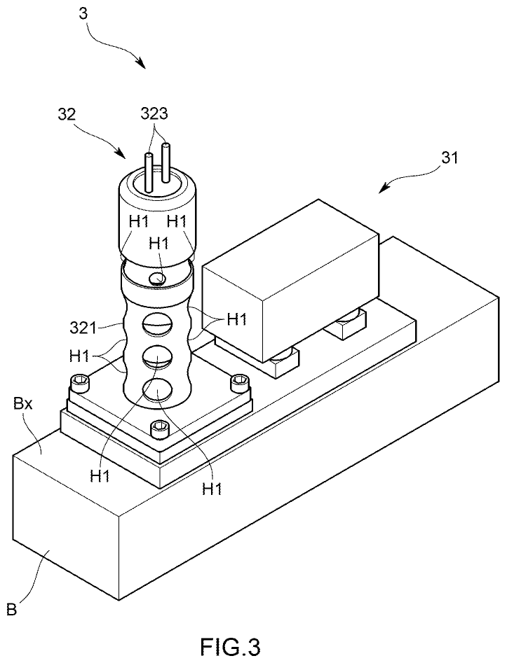

For example, a plurality of vent holes H1 have the same size and the same shape in the embodiment described above, but as illustrated in FIG. 3, some of a plurality of vent holes H1 may have a size or shape different from that of the other vent holes H1. Each of the vent holes H1 here has a circular shape, and the vent hole H1 formed on the one end side is smaller than the vent hole H1 formed on the other end side, but the shapes and sizes of the vent holes H1 are not limited to this configuration and may be appropriately changed. Note that the main case 33 is omitted in FIG. 3.

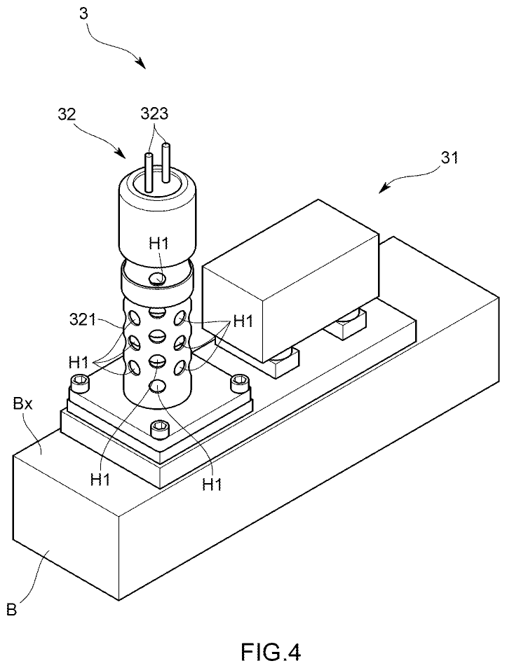

As illustrated in FIG. 4, a plurality of vent holes H1 may be arranged to be staggered along the axial direction. That is, the vent holes H1 adjacent along the circumferential direction may be disposed at different heights in the axial direction. Furthermore, the vent holes H1 need not be arranged regularly but may be arranged irregularly. Note that the main case 33 is omitted in FIG. 4.

Furthermore, the casing 321 does not necessarily need a plurality of vent holes H1. A single vent hole H1 may be formed in the casing 321. The casing 321 of the embodiment described above has a cylindrical shape, but the casing 321 may have a shape having a polygonal cross-section to have enhanced strength. In this case, the vent hole H1 may be formed at a side or an apex in a cross section.

The vent hole H1 needs not have a circular shape, but may have, for example, a slit shape, a triangular shape, a rectangular shape, or a polygonal shape.

The second vent hole H2 is not necessarily formed in the vertically downward facing surface or the vertically upward facing surface. Instead of or in addition to these surfaces, the second vent hole H2 may be formed in a surface orthogonal to these surfaces.

Furthermore, a plurality of second vent holes H2 are not necessarily formed in the main case 33. The main case 33 may have a single second vent hole H2 or no second vent hole H2.

The second vent hole H2 does not need to have a circular shape, but may have, for example, a slit shape, a triangular shape, a rectangular shape, or a polygonal shape.

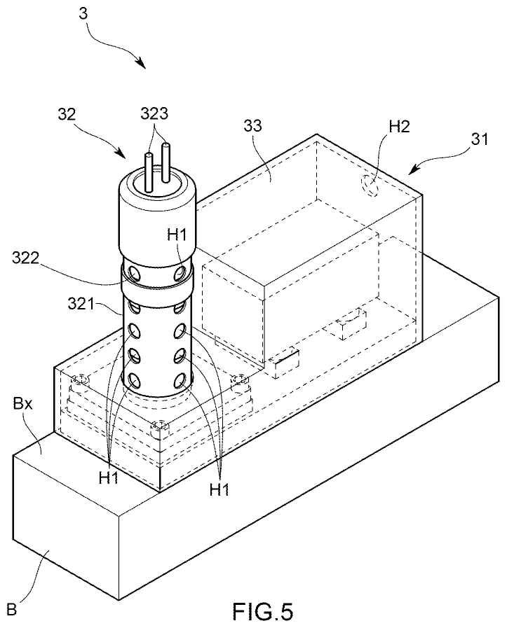

In the embodiment described above, only the upper portion of the casing 321 protrudes from the main case 33. However, as illustrated in FIG. 5, half or more of the casing 321 may protrude from the main case 33 and half or more or all of the vent holes H1 in the casing 321 may be outside the main case 33.

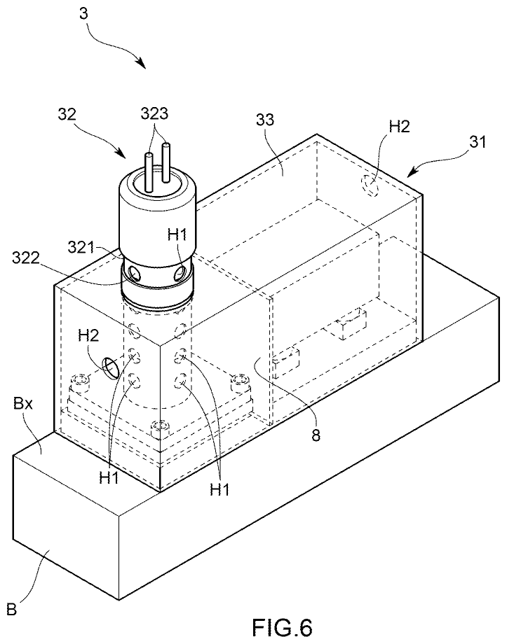

Furthermore, the flow path for the gas flowing into the main case 33 from the second vent hole H2 may bypass the fluid detection device 31. Such specific aspects include an aspect, as illustrated in FIG. 6, in which the fluid control device 3 includes a shielding member 8 housed in the main case 33 to shield the fluid detection device 31 from the gas flowing into the main case 33 from the second vent hole H2.

Examples of the shielding member 8 include a flat plate member or a curved member interposed between the second vent hole H2 through which the gas flows in and the fluid detection device 31, and a member (not illustrated) surrounding the fluid detection device 31.

This configuration can inhibit thermal influence on the fluid detection device 31, and can secure the accuracy of measuring a flow rate or pressure by the fluid detection device 31.

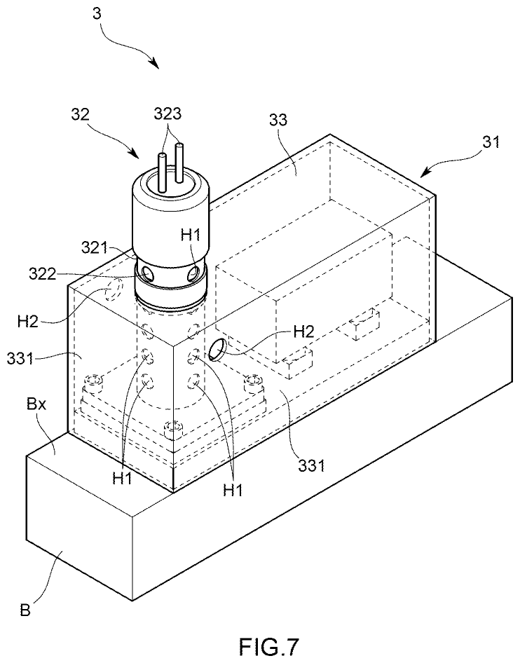

In another aspect in which the flow path described above bypasses the fluid detection device 31, for example, as illustrated in FIG. 7, the second vent hole H2 is formed in each of the side surfaces 331 facing each other in the width direction of the main case 33 (that is, the side surfaces 331 along the longitudinal direction of the main case 33) at places facing the fluid control valve 32.

Furthermore, in the embodiment described above, both the fluid detection device 31 and the fluid control valve 32 are housed in the main case 33, but the fluid detection device 31 may not be housed in the main case 33.

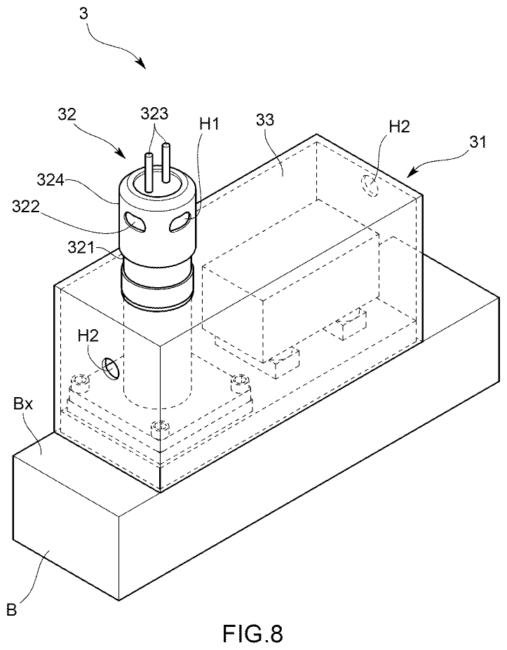

In addition, as illustrated in FIG. 8, it may be configured that a part of the fluid control valve 32 on the opposite side of the block body B of the casing 321 is a detachable cap 324 (for example, a nut) and one or a plurality of vent holes H1 are formed in the distal end portion, for example, of the cap 324.

This configuration, in which at least the distal end portion of the cap 324 protrudes from the main case 33, can release the hot air in the casing 321 to the outside of the main case 33, so that less portion of the fluid control valve 32 protrudes from the main case 33.

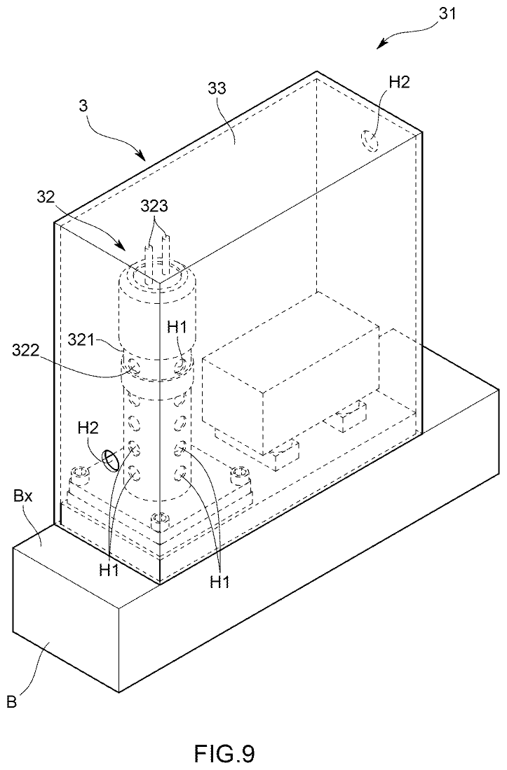

In addition, as illustrated in FIG. 9, the fluid control device 3 may be configured to house the entire fluid control valve 3 in the main case 33.

### Second Embodiment

A fluid control valve, a fluid control device including the fluid control valve, and a material supply system including the fluid control device according to a second embodiment of the present invention will be described with reference to the drawings.

### <Device Configuration>

A material supply system 100 of the present embodiment is different from that of the first embodiment in the configuration of the fluid control device 3. Thus, the difference in the configuration and the structure around the configuration will be described, and description of other configurations will be omitted.

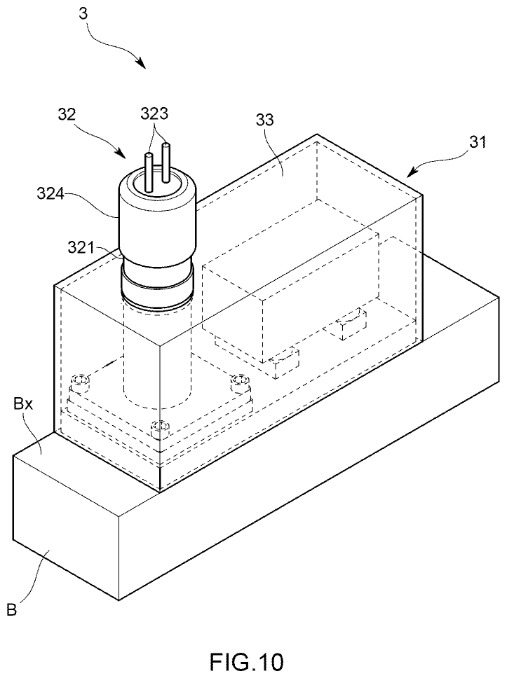

Like in the first embodiment, a fluid control device 3 of the present embodiment is a mass flow controller including a fluid detection device 31, a fluid control valve 32, and a main case 33, and the fluid detection device 31 and the fluid control valve 32 are attached to a device mounting surface Bx of a block body B including an internal flow path, and are housed in the main case 33 attached to the block body B. As illustrated in FIG. 10, the fluid control valve 32 of the present embodiment is different from that of the first embodiment in that a vent hole H1 is not formed in a casing 321.

As illustrated in FIG. 10, the fluid control device 3 is configured that the fluid control valve 32 can be accessed without removing the main case 33 from the block body B.

That the fluid control valve 32 can be accessed means that at least a part constituting the fluid control valve 32 can be replaced or maintained. In this embodiment, at least a piezo actuator 322 can be replaced with a new one.

In the present embodiment, as illustrated in FIG. 10, a part of the fluid control valve 32 protrudes from the main case 33. More specifically, a cap 324 constituting an end portion of the casing 321 protrudes from the main case 33, in other words, the cap 324 is outside the main case 33.

### Effects of Present Embodiment

According to the fluid control device 3 configured in this manner, the fluid control valve 32 can be replaced with a new one without replacing the whole fluid control device 3, that is, it is unnecessary to replace other components such as the fluid detection device 31 which is still usable.

In addition, since the cap 324 is outside the main case 33, the cap 324 is easily accessible to replace the fluid control valve 32 with a new one without replacing the whole fluid control device 3.

### Exemplary Modification of Second Embodiment

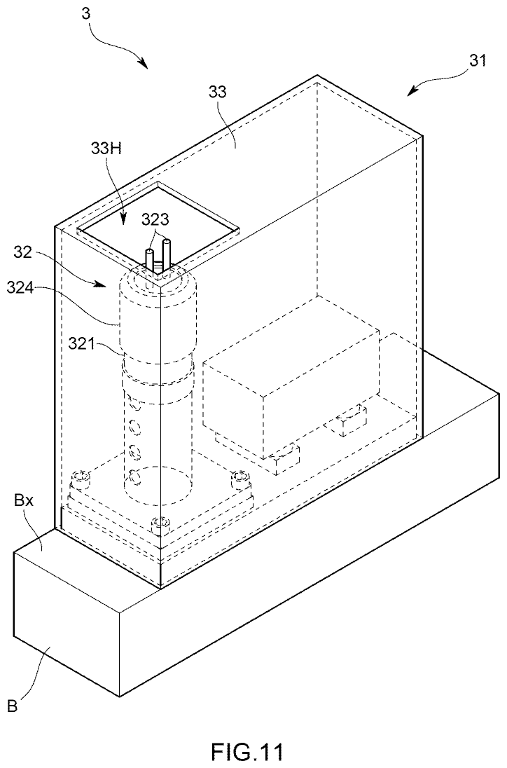

For example, a part of the fluid control valve 32 protrudes from the main case 33 in the embodiment described above. But as illustrated in FIG. 11, an opening 33H is formed at a place on the main case 33 facing the fluid control valve 32. As long as the fluid control valve 32 is accessible through the opening 33H, the entire fluid control valve 32 may be housed in the main case 33.

Specifically, the opening 33H is formed in a side surface of the main case 33 at a place facing a distal surface of the cap 324 (the surface on which a terminal 323 is provided), and has such a size that includes the entire cap 324 in a plan view. The shape of the opening 33H may be appropriately changed, for example, to a rectangular shape or a circular shape.

This configuration, in which the whole fluid control valve 32 is housed in the main case 33, allows easy replacement of the fluid control valve 32 with a new one without replacing the whole fluid control device 3.

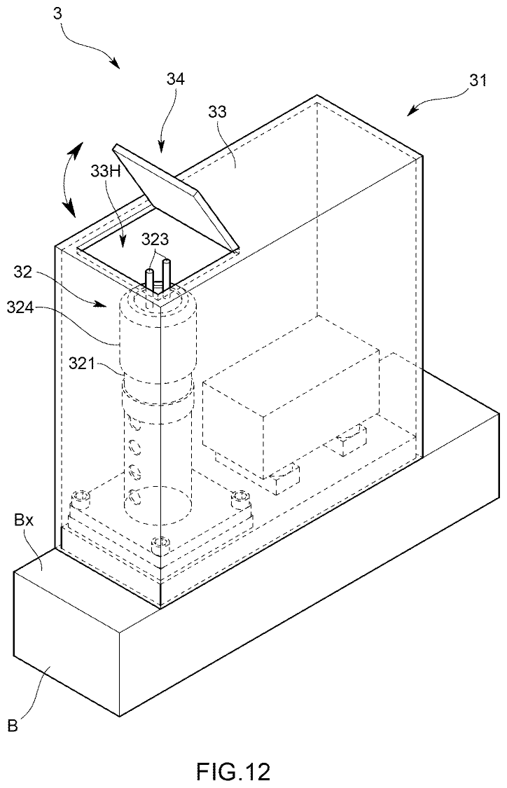

As illustrated in FIG. 12, the fluid control device 3 may include an opening/closing mechanism 34 that opens and closes the opening 33H described above.

Aspects of the opening/closing mechanism 34 include that including a plugging member that plugs the opening 33H and a moving mechanism that movably holds the plugging member between a plug position to close the opening 33H and an open position to open the opening 33H.

This configuration allows access to the fluid control valve 32 without removing the main case 33, and thus secures internal air tightness of the main case 33.

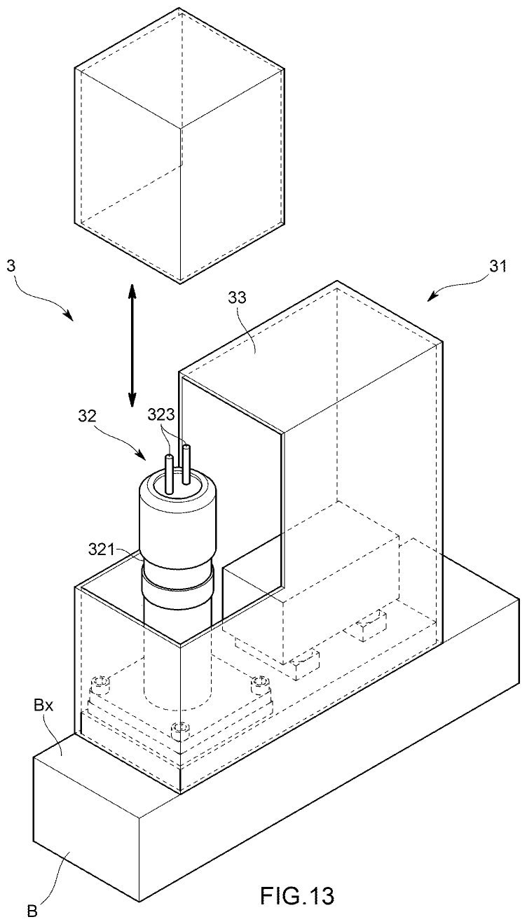

Furthermore, as illustrated in FIG. 13, the fluid control device may be configured that parts surrounding the fluid control valve 32 in the main case 33 are detachable. More specifically, at least parts surrounding the cap 324 in the main case 33 are desirably detachable.

In this configuration, the fluid control valve 32 can be accessed easily by removing the parts of the main case 33 surrounding the fluid control valve 32.

### Other Embodiments

The fluid control device 3 according to an embodiment of the present invention is not limited to those used for the vaporizing system 100, but may be applied to various systems for controlling a high-temperature fluid.

Various modifications and combinations of the embodiments may be made without departing from the spirit of the present invention.

### DESCRIPTION OF REFERENCE CHARACTERS

100 vaporizing system (material supply system)
B block body
C outer case
2 vaporizing unit
3 mass flow controller
31 fluid detection device
32 fluid control valve
33 main case
33H opening
321 casing
322 piezo actuator
323 terminal
324 cap
H1 vent hole
H2 second vent hole
4 control device
5 shielding member

What is claimed is:

1. A fluid control valve comprising:
a casing; and
a piezo actuator that is housed in the casing and held at one end side of the casing to extend toward another end side of the casing, wherein the casing has a vent hole.

2. The fluid control valve according to claim 1, wherein the vent hole is formed at each of a plurality of places on the casing.

3. The fluid control valve according to claim 2, wherein the vent hole is formed at each of a plurality of places along a circumferential direction of the casing.

4. The fluid control valve according to claim 2, wherein the vent hole is formed at each of a plurality of places along an axial direction of the casing.

5. The fluid control valve according to claim 2, wherein some of a plurality of the vent holes have a size or shape different from a size or shape of others of the plurality of the vent holes.

6. The fluid control valve according to claim 2, wherein the vent hole is formed on each of the one end side and the other end side of the casing, and gas flowing in through the vent hole on the other end side of the casing passes inside the casing and flows out from the vent hole on the one end side of the casing.

7. A fluid control device comprising:
the fluid control valve according to claim 1; and
a main case that houses the fluid control valve.

8. The fluid control device according to claim 7, wherein a part of the fluid control valve protrudes from the main case.

9. The fluid control device according to claim 7, wherein a second vent hole is formed in the main case.

10. The fluid control device according to claim 9, wherein the second vent hole is formed in each of surfaces of the main case, the surfaces facing opposite directions.

11. The fluid control device according to claim 10, wherein the surfaces facing opposite directions are a vertically downward facing surface and a vertically upward facing surface, and gas flowing in through the second vent hole in the vertically downward facing surface passes inside the main case and flows out from the second vent hole in the vertically upward facing surface.

12. The fluid control device according to claim 9, further comprising a fluid detection device that is housed in the main case and detects a fluid controlled by the fluid control valve, wherein a flow path for gas flowing into the main case from the second vent hole is formed to bypass the fluid detection device.

13. The fluid control device according to claim 12, further comprising a shielding member that is housed in the main case and shields the fluid detection device from gas flowing into the main case from the second vent hole.

14. A material supply system comprising the fluid control device according to claim 7, wherein the material supply system supplies a liquid material or a material gas obtained by vaporizing a liquid material to a predetermined supply destination.

15. The material supply system according to claim 14, wherein a second vent hole is formed in the main case, and further comprising an outer case that houses the fluid control device and includes a purge gas introduction port, wherein purge gas introduced from the purge gas introduction port passes inside the main case through the second vent hole in the main case.

16. A fluid control valve comprising:
a casing; and
a piezo actuator including a piezoelectric element covered with an expandable covering member and housed in the casing, wherein the casing has a vent hole.
